(19) United States
(12) Patent Application Publication
(10) Pub. No.: US 2024/0343896 A1
(43) Pub. Date: Oct. 17, 2024

(54) Glass Fiber Thermoplastic Polypropylene Polymer Master Batch Composite

(71) Applicant: Tundra Composites, LLC, White Bear Lake, MN (US)

(72) Inventors: Adam Bartel, St. Paul, MN (US); John Keefe, Minneapolis, MN (US)

(73) Assignee: Tundra Composites, LLC, White Bear Lake, MN (US)

(21) Appl. No.: 18/605,888

(22) Filed: Mar. 15, 2024

Related U.S. Application Data
(60) Provisional application No. 63/453,128, filed on Mar. 19, 2023.

(51) Int. Cl. C08L 23/12; C08J 3/22; C08J 5/04

(52) U.S. Cl. CPC C08L 23/12; C08J 3/223; C08J 5/043; C08J 2323/12; C08L 2310/00

(57) ABSTRACT

The claimed masterbatch material relates to a glass fiber, polar additive, and thermoplastic polypropylene polymer composite and masterbatch having enhanced modulus, viscoelastic and rheological properties.

### FIELD

Disclosed is a masterbatch composite of a glass fiber and a propylene polymer. The composite has improved processing characteristics, improved structural product properties that produce enhanced products. The novel properties are produced in the composite by novel interactions of the fiber components and polymer components.

### BACKGROUND

Blended materials have been made for many years by combining generally two or more dis-similar materials to obtain beneficial properties from the combination. In a true composite, the interactions of the component materials provide the best properties and characteristics of both components. The use of a reinforcing fiber produces a range of materials and, under the correct conditions, can form a true polymer composite. In contrast, a simple filled polymer, following the rule of mixtures, with additive or filler, displays properties that are simply expected based on the nature of the materials. Fillers are often used as simple replacements for an expensive component to reduce costs in the composition. Strongly coupled materials, such as polymer to fiber or fiber to fiber, have minimal viscoelastic properties.

Substantial attention has been paid to the creation of composite materials with unique properties. Fiber and fabric reinforced polymer materials can include cellulosic fiber, high modulus polyolefin fiber, polybenzoxazole fiber, carbon fiber, aramid fiber, boron fiber, glass fiber and hybrid materials. Fiber can be used in reinforcing thermoplastics and thermosets. Epoxy and polyurethane thermosets are common. Polyolefin, polyvinyl chloride (PVC) and other thermoplastics and hybrids have been developed for a variety of end uses.

Developing thermoplastic composite materials have faced difficult barriers. To obtain significant thermal processing, tensile, modulus, impact, and coefficient of thermal expansion (COTE) properties, a composite must control the degree of interaction between reinforcing fiber and polymer and the degree of fiber loading in the polymer matrix. Highly filled composite polymer materials cannot be easily made. Melt processing thermoplastics and fibers are not easily combined due to differences in the polymer with respect to fiber character such as composition, density, surface energy and morphology. Excessive compounding processing to obtain a uniform composite can cause fiber damage and compounding extruder damage. The thermal depolymerization of the polymer with accompanying hazards of fire and toxic gasses can happen if process conditions are not carefully monitored. While fiber composites have been proposed with high fiber loadings, commercially, due to process limitations, products have rarely achieved more than about 50 wt. % fiber.

While a need for a masterbatch has been acute, a substantial amount of work has been done regarding fiber reinforced thermoplastic polymer composite materials, a substantial need exists for a composite material at greater than 70 wt. % fiber that has a fiber surface that is made more inert with respect to the polymer, improved fiber packing efficiency and with high fiber content, improved thermal compounding processing that maintains fiber integrity with improved rheology, and produce composites with improved structural properties at elevated use temperatures.

### BRIEF DESCRIPTION

A composite of glass or silicate fiber and a polypropylene polymer has improved and novel properties. The claimed composite is made of a combination of a thermoplastic polypropylene polymer, a polar modified polymer, and combination of an interfacial modified glass or silicate fiber. The composite can be made a continuous phase comprising the polymer or blend thereof and the modified polymer with about 70 to 90 wt. % of a discontinuous phase comprising the fiber. The composite properties result from a selection of fiber composition, length, diameter and aspect ratio, polymer type, molecular weight, viscoelastic character, and processing conditions. The resulting composite materials exceed the contemporary structural composites in at least one property such as packing, surface inertness, processability, COTE, tensile properties modulus and physical modulus. In the process of making the composite, the fiber input to the compounding process unit can have an arbitrary length, often about 0.8 to 100 mm. The product output of the compounding process unit can have a fiber of similar length, depending on process conditions. The fiber can be reduced in length if sheared in compounding. The composite containing the fiber can be pelletized. In the pellet, the fiber cannot be longer than the major dimension of the pellet.

One aspect of the claimed masterbatch material is a composite of interfacially modified coated glass fiber, polymer, and polar modified polymer. Fibers can be densified. Such a composite material is thermoplastic in character and can be extruded and then melted and reextruded.

Another aspect is a structural member made of the masterbatch composite. Such structural members can be used in commercial and residential construction and can include siding and fenestration units including decking, trim, windows, and doors.

Still another aspect is a pellet made of the composite (fiber at use concentrations) or a masterbatch composition (glass at increased amounts) that can be used as an intermediate article between the compounding of the composite and the manufacturing of the final product. Such a pellet can comprise the composite comprising the components designed to be directly used in making an article. Alternatively, the pellet can comprise a master batch composition with increased amounts of glass fiber such that the pellet can be combined with polymer in proportions that result in producing use or final article production concentrations.

A final aspect of the claimed material is a method of compounding the composite by compounding the combined polymer resin, polar modified polymer and interfacial modified glass blended fiber under conditions.

The term “polypropylene” means a branched, propene or propylene partially crystalline polymer, having a density of greater than 0.895 g-cm⁻³, often 0.900 to 0.930 g-cm⁻³ and a crystallinity at least 45% often greater than 55%. Such polymers can contain minor amounts of olefin monomers such as ethylene, butylene, octene, etc.

The term “a fiber” means a collection of similar fibers in a fibrous material combined with a polymer as input to a compounding process unit. Fiber as used in a discontinuous phase can be free of a particle or particulate. Silica is not a silicate. Silica typically comprised most of individual species as SiO₂. A silicate typically comprised most of individual species as a salt of a charged species as silicate such as SiO₃⁺² or SiO₄⁺⁴ or other charged similar silicate species.

The term “final article production concentrations” means a composite with amounts of glass fiber, typically less than 10 wt. %, often less than 50 wt. % used directly in making an article.

The term “masterbatch” means a composite with increased amounts of glass fiber, typically at least 70 wt. % or 77 wt. % used to make a final article production concentration composite by combining polymer with masterbatch.

The term “continuous phase” means the polymer matrix into which the fiber is dispersed during compounding.

The term “discontinuous phase” means the individual fibers that are dispersed throughout the continuous phase.

The term “interfacial modifier” (IM) means a material that can coat the surface of fiber and does not react or interact with the polymer or other coated fiber present in the composite. In one embodiment the IM is an organo-metallic material.

The term “densified” when used as a composite fiber material characteristic means a fiber source that is processed to increase the bulk density of the material such that is approaches the density of the polymer used in the composite. A silicate fiber that is naturally about 0.2 to 0.4 g-cc⁻³ density is processed to be at least 0.4 g-cc⁻³ or to 5 g-cc⁻³ or more in the composite.

### DESCRIPTION

Novel composites are made by combining an interfacial modified fiber, a polar modified polymer and thermoplastic polypropylene polymer to achieve novel physical and process properties. The fiber comprises a glass or a silicate fiber.

The composite can be made of a continuous phase comprising the polymer or blend thereof with at least 70, 77, 80 wt. % of a discontinuous phase comprising the glass fiber.

A masterbatch composite can also be made of at least about 70 wt. % of a discontinuous s phase comprising the glass fiber with adjusted amounts of polymer and polar polymer.

A large variety of thermoplastic polymer and copolymer materials can be used in composite materials. Vinyl polymers are typically manufactured by the polymerization of monomers having an ethylenically unsaturated olefinic group. The typical polymer has a density of at least 0.88 gm-cm⁻³, however, polymers having a density of greater than 0.92 are useful to enhance overall product density. A density is often 0.93 to 0.95 gm-cm⁻³.

Vinyl polymers include polymers of alpha-olefin such as propylene, often in combination with other olefin monomers in lesser amounts.

TABLE 1
Polypropylene polymer characteristics

| Property | Range | Range | Range |
|---|---|---|---|
| Specific Gravity, g-cm⁻³, | 0.87-0.95 | 0.89-0.93 | 0.98-0.91 |
| ASTM D792 | | | |
| Melt Flow, ASTM D1238 | 0.05-<80 | 0.3-60 | 0.3-30 |
| g-10 min⁻¹ | | | |
| Tensile Strength at Break, | 10-50 | 12-38 | 14-28 |
| MPa ASTM D638 | | | |
| Elongation at Break, (%) | 0.5-600 | >490 | >520 |
| ASTM D638 | | | |
| Flexural Modulus MPa, | 700-2000 | 800-1900 | 1000-1500 |
| ASTM D790 | | | |
| Deflection Temperature | 40-110 | 50-100 | 40-60 |
| ° C. at 1.8 MPa (264 psi), | | | |
| ASTM D648 | | | |

TABLE 2
Maleic Anhydride Modified Polypropylene polymer characteristics

| Property | Range | Range | Range |
|---|---|---|---|
| Maleic Anhydride content | 0.2-5 | 0.5-4 | 1-2 |
| wt. % | | | |
| Melt Flow, ASTM D1238 | >80-500 | 90-400 | 100-300 |
| g-10 min⁻¹ | | | |
| Specific Gravity, g-cm⁻³, | 0.87-0.95 | 0.89-0.94 | 0.98-0.93 |
| ASTM D792 | | | |
| Melting Point ° C. | 130-180 | 140-170 | 150-160 |

The masterbatch composite and pellets can contain a polar polyolefin additive such as a polyethylene or polypropylene modified with an effective amount often about 0.1 to 10 wt. % (based on polymer) of polar or ionic side groups or copolymer monomers to promote formation of the composite and maintain tensile properties. Polyolefin, such as polyethylene and a propylene, is a thermoplastic resin made from olefin (ethylene or propylene with other minor monomers) polymerization including isotactic, atactic and syndiotactic polymers.

Modified polyethylene includes copolymers of ethylene and a small amount of another olefin and is a translucent colorless, odorless, and nontoxic solid. It is crystallized due to its regular structure, with a melting point of about 125-135° C. In other words, strong polar side groups are introduced into the main chain of non-polar molecules.

Modified polypropylene includes copolymers of propylene and a small amount of ethylene and is a translucent colorless, odorless, and nontoxic solid. It is crystallized due to its regular structure, with a melting point of about 150-170° C. In other words, strong polar side groups are introduced into the main chain of non-polar molecules.

Another example of a polyolefin additive is a functionalized polyolefin that contains a polar and nonpolar component. The polar component may, for example, be provided by one or more functional groups and the nonpolar component may be provided by an olefin. The olefin component of the additive may generally be formed from any linear or branched α-olefin monomer, oligomer, or polymer (including copolymers) derived from an olefin monomer, such as described above. The functional group of the additive may be any group, molecular segment and/or block that provides a polar component to the molecule. The functional group can have an ionic nature and comprise charged metal ions. Particularly suitable functional groups are maleic anhydride, maleic acid, fumaric acid, maleimide, maleic acid hydrazide, a reaction product of maleic anhydride and diamine, methyl maleic anhydride, dichloromaleic anhydride, maleic acid amide, etc. Maleic anhydride modified polyolefins are particularly suitable for use in the present invention. Such modified polyolefins are typically formed by grafting maleic anhydride onto a polymeric backbone material.

Suitable monomers for polymer polar modification are for example 1,4-cyclohexane dimethanol divinyl ether, 2-methyl-N-vinylimidazole, vinyl 4-tert.-butylbenzoate, acrolein, acrylamide, acrylonitrile, acrylic acid, allyl methacrylate, butanediol dimethacrylate, butanediol vinylether, butanediol monoacrylate, butanediol monovinyl ether, butanediol methylmethacrylate, butyl acrylate, butyl methacrylate, cyclohexyl vinyl ether, diethylene glycol divinyl ether, dimethyl amino ethyl acrylate, dimethyl amino ethyl methacrylate, dimethyl amino propyl methacrylamide, ethyl acrylate, ethyl diglycol acrylate, ethylene glycol dimethacrylate, ethylene glycol monovinyl ether, ethyl hexyl acrylate, ethyl methacrylate, glycidyl methacrylate, hydroxyethyl methacrylate, hydroxypropyl methacrylate, isobutene, isobutyl acrylate, isobutyl methacrylate, maleic anhydride, methacrylic acid, methacrylic acid anhydride, methyl acrylate, methylene bis-acrylic amide, methylmethacrylate, methyl vinyl ether, n-butyl vinyl ether, N-methyl-N-vinyl acetamide, N-vinyl caprolactam, N-vinyl imidazole, N-vinylpyrrolidone, phenoxy ethyl acrylate, t-butyl acrylamide, t-butyl acrylate, t-butyl methacrylate, triethylene glycol dimethyl acrylate, triethylene glycol divinyl ether, triethylene glycol divinyl methyl ether, trimethylol propane trimethyl acrylate, vinyl acetate, vinyl formamide, N-vinyl piperidone, vinyl-(2-ethylhexyl) ether, vinyl propyl ether, vinyl isopropyl ether, vinyl dodecyl ether, vinyl-t-butyl ether, hexanediol divinyl ether, hexanediol monovinyl ether, diethylene glycol monovinyl ether, diethylamino ethyl vinyl ether, polytetrahydrofuran-divinyl ether, tetra ethylene glycol divinyl ether, ethylene glycol butyl vinyl ether, ethylene glycol divinyl ether, trimethylolpropane trivinyl ether and amino propyl vinyl ether.

Maleic anhydride is preferred as the monomer that is grafted at less than about 10 wt. %, 5 wt. % or 2 wt. % at a suitable temperature. The disadvantage is poor to low temperature impact resistance, easy to age, but can be overcome by modification, maleic anhydride polypropylene is one of them. Maleic anhydride polypropylene is prepared by reactive extrusion grafting maleic anhydride onto polypropylene. Polar side group modified polymer can improve the adhesion and compatibility between polar and non-polar materials. Adding modified polymer in the production of composites of polypropylene can greatly improve the affinity and dispersion of fiber in polypropylene to improve the tensile and impact strength of filled polypropylene.

Each of the individual fibers of the generic, useful fiber material has a cross-section dimension (preferably but not limited to a diameter) of at least about 0.8 micron often about 1-150 microns and can be 2-100 microns, or 5 to 10 microns, a length of 0.1-150 mm, often 0.2-100 mm, and often 50 to 100 mm and can have an aspect ratio of at least 90 often about 100-1500. After pellets are formed the aspect ratio is set by the pellet dimensions. In certain circumstances, a silicate material can be used that has an aspect ratio of less than 3 and a circularity of greater than 20, often 25-100 or 30 to 100. In this embodiment, the non-circular rough or irregular morphology provides the reinforcement in combination with the fiber. More circular materials provide little reinforcements. The more the material departs from the near circular and obtains an irregular morphology, the more reinforcement is obtained in the resulting composite.

A glass fiber known by the designations: A, C, D, E, Zero Boron E, ECR, AR, R, S, S-2, N, and the like is useful. Generally, any glass that can be made into fibers either by drawing processes used for making reinforcement fibers or spinning processes used for making thermal insulation fibers. Such fiber is typically used as a length of about 0.8-100 microns often about 2-100 microns, a diameter about 0.8-100 microns and an aspect ratio (length divided by diameter) greater than 90 or about 100 to 1500.

These commercially available fibers are often combined with a sizing coating. Such coatings cause the otherwise ionically neutral glass fibers to form and remain in bundles or fiber aggregates. Sizing coatings are applied during manufacture before gathering. The sizing minimizes filament degradation caused by filament-to-filament abrasion. Sizings can be lubricants, protective, or reactive coupling agents but do not contribute to the properties of a composite using an interfacial modifier (IM) coating on the fiber surface. Sizings are not interfacial modifiers.

Certain of these types of IM compounds may be defined by the following general formula:

M(R₁)ₙ(R₂)ₘ

wherein M is a central atom selected from such metals as, for example, Ti, Al, B, and Zr and other metal centers; R₁ is a hydrolysable group; R₂ is a group consisting of an organic moiety, preferably an organic group that is non-reactive with polymer or other film former; wherein the sum of m+n must equal the coordination number of the central atom and where n is an integer ≥1 and m is an integer ≥1. Interfacial modifiers used in the application fall into broad categories including Group IIIA, or Group VIB element compounds, for example, titanate compounds, zirconate compounds, hafnium compounds, boron compound, iron compounds, cobalt compounds, nickel compounds, samarium compounds, strontium compounds, neodymium compounds, yttrium compounds, phosphonate compounds, aluminate compounds and zinc compounds. Aluminates, boronates, phosphonates, titanates and zirconates that are useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen, and sulfur

In one embodiment, the interfacial modifier that can be used is a type of organo-metallic material such as organo-cobalt, organo-iron, organo-boron, organo-nickel, organo-titanate, organo-aluminate organo-strontium, organo-neodymium, organo-yttrium, organo-zinc, or organo-zirconate. The specific type of organo-titanate, organo-aluminates, organo-boronate, organo-strontium, organo-neodymium, organo-yttrium, organo-zirconates which can be used, and which can be referred to as organo-metallic compounds are distinguished by the presence of at least one hydrolysable group and at least one organic moiety. Mixtures of the organo-metallic materials may be used. Particularly R₁ can be an alkoxy group having less than 12 carbon atoms. Other useful groups are those alkoxy groups, which have less than 6 carbons, and alkoxy groups having 1-3 C atoms. R₂ is an organic group including between 6-30, preferably 10-24 carbon atoms optionally including one or more hetero atoms selected from the group consisting of N, O, S and P. R₂ is a group consisting of an organic moiety, which is not easily hydrolyzed and is often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R₂ is substantially unreactive, i.e., not providing attachment or bonding, to other particles. Titanates provide antioxidant properties and can modify or control cure chemistry. A titanate material can be 2-propanolato, tris iso-octa-decanato-O-titanium IV, an isopropyl tri-isostearoyl titanate. Zirconate provides excellent coating and reduces formation of off color in formulated thermoplastic materials. A useful zirconate material is neopentyl (diallyl) oxy-tri (dioctyl) phosphato-zirconate.

The use of an interfacial modifier results in workable viscosity and improved structural properties in a final use such as a structural member or shaped article. Minimal amounts of the modifier can be used including about 0.005 to 10 wt.-%, about 0.01 to 8 wt.-%, about 0.05 to 6 wt.-%, or about 0.04 to 2 wt. % based on the weight final composite.

The IM coating, with no other components, can be formed as a coating of a dimension equal to at least 3 molecular layers of IM. A substantially complete IM coating has a thickness of less than 1500 Angstroms often less than 200 Angstroms, and commonly 100 to 5000 Angstroms (Å) 50 to 1000 Angstroms (Å) or 10 to 500 Angstroms (Å).

A composite is more than a simple admixture with properties that can be predicted by the rule of mixtures. A composite is defined as a combination of two or more substances at various percentages, in which each component results in properties of the composite material that are in addition to or superior to those of its constituents. In a simple admixture, the mixed material has little interaction and little property enhancement. In a composite material, at least one of the materials can be chosen to increase stiffness, strength, or density.

The atoms and molecules in the components of the composite can form bonds with other atoms or molecules using several mechanisms. Such bonding can occur between the electron cloud of an atom or molecular surfaces including molecular-molecular interactions, atom-molecular interactions, and atom-atom interactions. Each bonding mechanism involves characteristic forces and dimensions between the atomic centers even in molecular interactions. The important aspect of such bonding force is strength and the variation of bonding strength over distance and directionality. The major forces in such bonding include ionic bonding, covalent bonding, and the van der Waals' (VDW) types of bonding.

Ionic radii and bonding occur in ionic species such as Na⁺Cl⁻, Li⁺F⁻. Such ionic species form ionic bonds between the atomic centers. Such bonding is substantial, often substantially greater than 100 kJ-mol⁻¹ often greater than 250 kJ-mol⁻¹. Further, the interatomic distance for ionic radii tend to be small and about 1-3 Å. Covalent bonding results from the overlap of electron clouds surrounding atoms forming a direct covalent bond between atomic centers. The covalent bond strengths are substantial, are roughly equivalent to ionic bonding and tend to have somewhat smaller interatomic distances.

The varied types of van der Waals' forces are different than covalent and ionic bonding. These van der Waals' forces tend to be lesser forces between molecules, not between atomic centers. In the composites of the claimed materials strong covalent or ionic bonding is avoided. Reactive coupling agents that bond polymer to fiber are not used. The blended fiber polymer composite as shown in the embodiments is formed with minimal van der Waals bonding as modified by the IM coating.

Bonding of strength less than covalent, ionic or hydrogen bonding arise by the separation of charges on a molecule creating a generally or partially positive end and a generally or partially negative opposite end. The forces arise from electrostatic interaction between the molecule's negative and positive regions. Hydrogen bonding is a dipole-dipole interaction between a hydrogen atom and an electronegative region in a molecule, typically comprising oxygen, fluorine, nitrogen or other relatively electronegative (compared to H) site. These atoms attain a dipole negative charge attracting a dipole-dipole interaction with a hydrogen atom having a positive charge.

The van der Waals' force existing between substantially non-polar uncharged molecules arises from the movement of electrons within the molecule. Because of the rapidity of motion within the electron cloud, the non-polar molecule attains a small but meaningful instantaneous charge as electron movement causes a temporary change in the polarization of the molecule. These minor fluctuations in charge result in the dispersion portion of the van der Waals' force.

Such VDW forces, because of the nature of the fluctuating polarization of the molecule, tend to be low in bond strength (compared to covalent bonding), typically 50 kJ mol⁻¹ or less, often approaching zero. Further, the range at which the force becomes attractive is also substantially greater than ionic or covalent bonding and tends to be about 3-10 Å.

The prior art materials having little viscoelastic properties, do not achieve a true composite structure as now described. This leads us to conclude that this minimal intermolecular distance is not attained in the reference materials in the absence of interfacial modifier. In the discussion above, the term “molecule” can be used to relate to a fiber, a fiber comprising non-metal crystal or an amorphous aggregate, other molecular or atomic units or sub-units of non-metal or inorganic mixtures. The van der Waals' forces occur between collections of metal atoms, embodiments of the interfacial modifier, which act as “molecules.”

In the masterbatch with an interfacial modifier, disclosed below, the fibers can achieve a close packing attained through the minimal VDW forces and no covalent bonding. The intermolecular forces between fibers can be less than about 50 or less than 30 kJ-mol⁻¹ and a bond dimension of 3-10 Å. The fiber in the composite, the reinforcement, is usually much stronger and stiffer than the polymer matrix, and gives the composite its good properties in, for example a shaped article, structural member, or other end use. The matrix holds the reinforcements in an orderly high-density pattern. Because the reinforcements are usually discontinuous, the matrix also helps to transfer load among the reinforcements. Processing can aid in the mixing and filling of the reinforcement or fiber. To aid in the mixture, an interfacial modifier can help to overcome the forces that prevent the matrix from forming a substantially continuous phase in the composite. The composite properties arise from the intimate association of interfacially modified fiber and polymer obtained by use of careful processing and manufacture.

Both fiber types of the fiber blend, such silicate and silica, are typically coated with an interfacial surface chemical treatment also called an interfacial modifier (IM) that supports or enhances the final properties of the composite such as viscoelasticity, rheology, high packing fraction, and fiber surface inertness. These properties are not present in contemporary composite materials. The fibers can be coated separately, or the fibers can be combined and then coated with the interfacial modifier. An interfacially modified fiber has a substantially complete coating of an interfacial modifier (IM) on the fiber surface with a thickness of less than 1500 Angstroms often less than 200 Angstroms, and commonly 10 to 500 Angstroms (Å) or 100 to 1500 Angstroms (Å).

The benefit of interfacial modification on a fully coated fiber is independent of overall fiber shape. The current upper limit constraint is associated with challenges of successful dispersion of fibers within laboratory compounding equipment without significantly damaging the high aspect ratio fibers. Furthermore, inherent rheological challenges are associated with high aspect ratio fibers. With proper engineering, the ability to successfully compound and produce interfacially modified fibers or fiber fragments with aspect ratio more than 20 often more than 100, 200 or more is provided.

For composites containing high volumetric loading of fibers, the rheological behavior of the highly packed composites depends on the characteristics of the contact points between the fibers and the distance between fibers. When forming composites with polymeric volumes approximately equal to the excluded volume of the discontinuous fiber phase, inter-fiber interaction dominates the behavior of the material. Fibers contact one another and the combination of interacting sharp edges, soft surfaces (resulting in gouging) and the friction between the surfaces prevent further or optimal packing. Interfacial modifying chemistries can alter the surface of the fiber by coordination bonding, Van der Waals forces, or a combination. The surface of the interfacially modified fibers behave as fibers formed of the non-reacted end or non-reacting end of the interfacial modifier. The coating of the interfacial modifier improves fiber surface wetting by the polymer and as a result improves the physical association of the fiber and polymer in the formed composite leading to improved physical properties including, but not limited to, increased tensile and flexural strength, increased tensile and flexural modulus, improved notched IZOD or Gardner impact results and reduced coefficient of thermal expansion.

In the melt, the interfacial modified coating on the fiber reduces the friction between fibers thereby preventing gouging and allowing for greater freedom of movement between fibers in contrast to fibers that have not been coated with interfacial modifier chemistry. Thus, the composite can be melt-processed at greater productivity and at conditions of reduced temperature and pressure severity. The process and physical property benefits of utilizing the coated fibers in the acceptable fiber morphology index range does not become evident until packing to a significant proportion of the maximum packing fraction; this value is typically greater than approximately 70, 80, 90, 92 or 95 volume or weight % of the fiber phase in the composite. Useful weight % of the fiber phase in the claimed masterbatch composite can be adjusted to above 70, 75, 77 or 80 wt. %, depending on the fiber concentration and end use of the article or structural member and the required physical properties of the article or structural member, without loss of processability via melt-processing, viscoelasticity, rheology, high packing fraction, and fiber surface inertness of the composite.

In a composite, the fiber is usually much stronger and stiffer than the polymer matrix and gives the composite its designed structural or shaped article properties. The polymer matrix holds the fiber in an orderly high-density pattern. Because the fibers are usually discontinuous, the matrix also helps to transfer load among the non-metal, inorganic, synthetic, natural, or mineral fibers. Processing can aid in the mixing and filling of the non-metal, inorganic or mineral fibers.

An interfacial modifier (IM) is an organic material that provides an exterior coating on the fiber promoting the close association of polymer and fiber. Minimal amounts of the interfacial modifier can be used on regular morphology while higher amounts of the IM are used to coat materials with increased or irregular surface morphology. Typically, the coated, blended fiber, polymer composite materials can be manufactured using melt processing and are also utilized in product formation using melt processing such as extrusion, injection molding and the like.

To interfacially modify at a lab scale, the interfacial modifier is first solubilized with a solvent such as IPA. The solvent/modifier mixture is applied to a fiber portion previously placed within a preparation vessel. The solvent/modifier mixture is added in enough volume to fully wet and flood the fiber. The outer part of vessel is then heated to volatize the solvent. After a sufficient time, the modified fiber becomes free flowing—an indication that they are ready for compounding and thermoplastic processing. The extruded or injection molded member can be formed as a linear member or a hollow profile.

The improved process viscosity can be seen in comparing the processing of a composite as claimed compared to a composite of uncoated fiber. The claimed materials have substantially reduced processing viscosity that is derived from the freedom of movement of the interfacially modified fiber within the polymer matrix. IM use also provides some fiber self-ordering which increases fiber packing fraction without the loss of rheology or breakage of fibers.

We used a C. W. Brabender Computerized Plasti-Corder test mixer equipped with a 19.1 mm, (¾ in.) diameter extruder with a 25/1 length/diameter ratio. The extrusion screw had ten feed flights, 10 compression flights with a compression ratio of 3:1, and 5 metering flights. Operating parameters were controlled by 5 independent heating zones, four pressure transducers and a torque-measuring drive unit. Software module was used for extrusion data. The capillary die, made from #416 stainless steel, had a diameter of 2 mm and a length of 40 mm. In operation, the operating conditions were set, and the blended fiber polymer composite was then extruded until equilibrium (constant throughput and constant die pressure) were reached. Extrusion at 40 rpm and a die pressure of about 28 Mpa were used. Brabender viscosity is reported as torque according to the appropriate ASTM protocol in N-m.

The composite, thus, obtains improved physical properties such as notched IZOD impact strength (ft-lb-in⁻¹) (ASTM D256), tensile strength (lb-in²), modulus (lb.×10⁶ in⁻²) and elongation (%) (ASTM D638/D3039) flexural strength (lb-in²) and modulus (lb.×10⁶-in⁻²) at elevated temperature (ASTM 790), and coefficient of thermal expansion (in-in⁻¹-° C.) (COTE—ASTM 696). Such properties are seen over a range of environmental temperatures.

Polymer blends or polymer alloys can be useful in manufacturing the claimed pellet or linear extrudate. Such alloys typically comprise two miscible polymers blended to form a uniform composition. Scientific and commercial progress in polymer blends has led to the realization that important physical property improvements can be made not by developing new polymer material but by forming miscible polymer blends or alloys. A polymer alloy at equilibrium comprises a mixture of two amorphous polymers existing as a single phase of intimately mixed segments of the two macro molecular components. Miscible amorphous polymers form glasses upon sufficient cooling and a homogeneous or miscible polymer blend exhibits a single, composition dependent glass transition temperature (T_{g}). Immiscible or non-alloyed blend of polymers typically displays two or more glass transition temperatures associated with immiscible polymer phases. In the simplest cases, the properties of polymer alloys reflect a composition-weighted average of properties possessed by the components. In general, however, the property dependence on composition varies in a complex way with a particular property, the nature of the components (glassy, rubbery, or semi-crystalline), the thermodynamic state of the blend, and its mechanical state whether molecules and phases are oriented.

There are two key attributes of the surface coating that dictate the ability to be successfully interfacially modified: 1) the overall surface area of fiber; and 2) fiber surface characteristics that are like the molecular size of the interfacial modifier being applied.

Sizing materials used as glass coatings do not act as interfacial modifiers. Sizing is essential in glass fiber manufacture and critical to certain glass fiber characteristics determining how fibers will be handled during manufacturing and use. Raw fibers are abrasive and easily abraded and reduced in size. Without sizing, fibers can be reduced to useless “fuzz” during processing. Sizing formulations have been used by manufacturers to distinguish their glass products from competitors' glass products. Glass fiber sizing, typically, is a mixture of several chemistries each contributing to sizing performance on the glass fiber surface. Sizings typically are manufactured from film forming compositions and reactive coupling agents. Once formed, the combination of a film forming material and a reactive coupler forms a reactively coupled film that is, reactively coupled to the glass fiber surface. The sizing protects the fiber, holding fibers together prior to molding but promote dispersion of the fiber when contacting polymer or resin insuring wet out of glass fiber with resin during composite manufacture. Typically, the coupling agent used with the film forming agent, is a reactive alkoxy silane compound serving primarily to bond the glass fiber to their matrix or film forming resin. Silane typically have a silicon containing group that bonds well to glass (typically SiO₂) with a reactive organic end that bonds well to film forming polymer resins. Sizings also may contain additional lubricating agents as well as anti-static agents. We have used sized fibers in our studies and found that sizing does not act as interfacial modifier and we can coat all sizing that we have found. While a sizing often contains coupling agents, an IM is free of coupling or reactive coupling agents.

Typically, composite materials can be manufactured using melt processing and are also utilized in product formation using melt processing. A typical thermoplastic polymer material is combined with IM coated blended fiber and processed until the material attains (e.g.) a uniform density (if density is the characteristic used as a determinant). Alternatively, in the manufacture of the material, the fiber or thermoplastic polymer may be blended with interfacial modification agents and the modified materials can then be melt processed into the material. Once the material attains a sufficient property, such as, for example, density, the material can be extruded into a product or into a raw material in the form of a pellet, chip, wafer, preform or other easily processed material using conventional processing techniques.

The manufacture of composite materials depends on good melt processing manufacturing technique. The fiber is initially treated with an interfacial modifier by contacting the fiber with the modifier directly or in the form of a solution of interfacial modifier on the fiber surface with blending and drying carefully to ensure uniform fiber coating. Interfacial modifier can also be added to fibers in bulk blending operations using high intensity Littleford or Henschel blenders. Alternatively, addition of the fiber blend to the twin cone mixers can be followed by drying or direct addition to a screw compounding device. Interfacial modifiers may also be combined with the fiber blend in aprotic solvent such as toluene, tetrahydrofuran, mineral spirits, or other such known solvents.

The fiber blend can be combined into the polymer phase depending on the nature of the polymer phase, the filler, the fiber surface chemistry and any pigment process aid or additive present in the composite material. The composite materials having the desired physical properties can be manufactured as follows. In an embodiment, the surface of the fiber is initially prepared, the interfacial modifier coats the fiber, and the resulting IM coated blended fiber product is isolated and then combined with the continuous polymer phase to affect an immiscible dispersion or association between the fiber and the polymer. Once the composite material is compounded or prepared, it is then melt-processed into the desired shape of the end use article.

Solution processing is an alternative that provides solvent recovery during materials processing. The materials can also be dry blended without solvent. Blending systems such as ribbon blenders obtained from Drais Systems, high-density drive blenders available from Littleford Brothers and Henschel are possible. Further melt blending using Banberry, other single screw or twin-screw compounders is also useful. When the materials are processed as a plastisol or organosol with solvent, liquid ingredients are generally charged to a processing unit first, followed by polymer, fiber, and rapid agitation. Once all materials are added a vacuum can be applied to remove residual air and solvent, and mixing is continued until the product is uniform and high in density.

Dry blending is generally preferred due to advantages in cost. However certain embodiments can be compositionally unstable due to differences in fiber size. In dry blending processes, the composite can be made by first introducing the polymer, combining the polymer stabilizers, if necessary, at a temperature from about ambient to about 80° C. with the polymer, blending an IM coated blended fiber with the stabilized polymer, blending other process aids, interfacial modifier, colorants, indicators, or lubricants followed by mixing in hot mix, transfer to storage, packaging, or end use manufacture. Fiber materials can be obtained or produced on site. Interfacially modified materials can be made with solvent techniques that use an effective amount of solvent to initiate formation of a composite.

Interfacially modified materials can be made with solvent techniques that use an effective amount of solvent to initiate formation of a composite. When interfacially modification is substantially complete, the solvent can be stripped. Such solvent processes are conducted by solvating the interfacial modifier or polymer or both; mixing a glass fiber with interfacial modifier into a bulk phase or polymer master batch and devolatilizing the composition in the presence of heat & vacuum above the Tg of the polymer.

When compounding with twin screw compounders or extruders, a process can be used employing twin screw compounding can be described as adding the glass fiber and raise temperature to remove surface water; adding interfacial modifier to the twin screw when the glass fiber is at temperature; dispersing or distributing interfacial modifier on the glass fiber; maintaining reaction temperature to completion; venting reaction by-products. Adding polymer; compressing and/or melting polymer; dispersing or distributing polymer onto the glass fiber; associating modified glass fiber with polymer binder; degassing remaining reaction products. Compressing resulting glass fiber and polymer composite and forming the desired shape, pellet, lineal, tube, injection mold article, etc. through a die or post-manufacturing step.

For alternative formulations containing small volumes, a process can be the following: adding polymer; adding interfacial modifier to twin screw when polymer is at temperature; dispersing or distributing interfacial modifier in the polymer; adding glass fiber; dispersing or distributing the fiber in the polymer, raising the temperature to reaction temperature; maintaining melt temperature to completion; compressing resulting glass fiber and polymer composite material; and forming desired shape, pellet, lineal, tube, injection mold article, etc. through a die or post-manufacturing step.

In another embodiment for formulations of glass fiber, a process could be adding polymer; raising the temperature of the polymer to a melt state; adding glass fiber which has been pre-treated with the interfacial modifier; dispersing and fiber and glass fiber in the polymer; compressing the resulting glass fiber and polymer composite; and forming the desired shape, pellet, lineal, tube, injection mold article, etc. through a die or post-manufacturing step.

The composite can be used to make a pellet. Such a pellet made of the composite can be used as an intermediate between the compounding of the composite and the manufacturing of the final product. A pellet can comprise the composite comprising the components in use concentration of components designed to be directly converted or used in making a useful article. Alternatively, the pellet can comprise a master batch composition with increased amounts, e.g., about 2 to 10 times the amount of fiber such that the pellet can be combined with polymer in proportions that result in producing use concentrations. The pellet is a roughly cylindrical object that can be fed into an extruder input. The pellet is typically 1 to 50, 1 to 60, 1 to 70, 1 to 80, 1 to 90, or 1 to 100 mm in height and 1 to 5, 1 to 10, 1 to 15, or 1 to 20 mm in diameter. A pellet weighs about 10 to 100 mg, 10 to 80 mg, 10 to 70 mg, 10 to 60 mg, 10 to 50 mg, 20 to 50 mg, 20 to 60 mg, 20 to 70 mg, 20 to 80 mg.

The composite can be used to make an article of manufacture. Such articles can be made directly from the compounding process or can be made from a pellet input. Articles can include pellets used in further melt-processing, structural members, or other articles that can be made using thermoplastic processing such as injection molding, compression molding, etc.

Structural members include linear extrudates that can be mechanically milled or reinforced with secondary members. The articles can be used in a fenestration unit as a frame member, muntin, grill etc. The articles can be used in a decking installation as a decking member, a trim, or a support. The article can be used as a rail, baluster, or post. The article can be used as a siding member.

The interior of the structural member is commonly provided with one or more structural webs which in a direction of applied stress supports the structure. Structural web typically comprises a wall, post, support member, or other formed structural element which increases compressive strength, torsion strength, or other structural or mechanical properties. Such structural web connects the adjacent or opposing surfaces of the interior of the structural member. More than one structural web can be placed to carry stress from surface to surface at the locations of the application of stress to protect the structural member from crushing, torsional failure, or general breakage. Typically, such support webs are extruded, or injection molded during the manufacture of the structural material.

TABLE 1
Exemplary Masterbatch Composites

| | Useful | Useful | Useful |
|---|---|---|---|
| | amounts | amounts | amounts |
| Component | (wt. %) | (wt. %) | (wt. %) |
| Glass fiber (wt. %) | ≤70 | ≤75 | ≤77 |
| Interfacial modifier | ≤2 | ≤1 | ≤0.5 |
| coating (wt. %) | | | |
| Thermoplastic | Balance | Balance | Balance |
| polymer (wt. %) | | | |
| Thermoplastic | ≥10 | ≥9 | ≥8 |
| polar modified | | | |
| polymer (wt. %) | | | |

TABLE 1
Exemplary Use Composites

| | Useful | Useful | Useful |
|---|---|---|---|
| Component | amounts | amounts | amounts |
| Glass fiber (wt. %) | 5-95 | 10-90 | 15-85 |
| Interfacial modifier | 0.1-5 | 0.3-3 | 0.5-2.5 |
| coating (wt. %) | | | |
| Thermoplastic | 55-99 | 75-95 | 75-90 |
| polymer (wt. %) | | | |
| Thermoplastic | 20-90 | 30-85 | 35-80 |
| polar modified | | | |
| polymer (wt. %) | | | |

Useful weight % of the fiber phase in the claimed composite can be adjusted to above 70, 80, or 90%, depending on the fiber concentration in the end use of the article or structural member and the required physical properties of the article or structural member, without loss of processability via melt-processing, viscoelasticity, rheology, high packing fraction, and fiber surface inertness of the composite.

With an IM, the composites can achieve the following properties:

TABLE 2
Typical use composite property ranges

| | ASTM | | | |
|---|---|---|---|---|
| Property | Method | Useful | Useful | Units |
| Flexural Strength | D790 | 80-160 | 70-150 | MPa (psi) |
| Flexural Modulus | D790 | 4000-10,000 | 4500-9500 | GPa (psi) |
| COTE | D696 | 1.0-2.0 × | <1.5 × | (in · in⁻¹ · ° F.) |
| | | 10⁻⁵ | 10⁻⁵ | |
| | | 2.0-3.0 × | <2.7 × | cm · cm⁻¹ · ° C. |
| | | 10⁻⁵ | 10⁻⁵ | |

Additionally, the use of the IM permits an increase in the fiber loading in the composite. As the fiber content increases, the polymer content decreases. The thermal expansion of a structural member made with the disclosed material will be improved as fiber content increases, e.g., the material will have reduced coefficient of thermal expansion (COTE).

### Experimental Section

### Examples

### Ex.1

Glass fibers from John Mansville 10-micron diameter and 4 mm length were coated with 2.1 pph interfacial modifier. The coated fibers were then compounded on a 70 mm twin screw extruder with 14.5% by weight polypropylene homopolymer MFI 12 g-10⁻¹ min. ASTM-1238 density 0.900 g-cm⁻³ ASTM 792 and 5.5% by weight maleic anhydride modified (4 wt. %) poly propylene MFI 400 g-10⁻¹ min to create an 80% by weight coated fiber composite. The extruder barrel temperatures were set from 170° C.-200° C. and pelletized. The pellets were injection molded on a ⅝″ injection-molder into test plaque for physical property evaluation.

### Ex. 2

Glass fibers from John Mansville 10-micron diameter and 4 mm length were coated with 2.1 pph interfacial modifier. The coated fibers were then compounded on a 70 mm twin screw extruder with 14.5% by weight polypropylene homopolymer MFI 12 g-10⁻¹ min. ASTM-1238 density 0.900 g-cm³ ASTM 792 and 5.5% by weight maleic anhydride modified (4 wt. %) polyethylene MFI 400 g-10⁻¹ min to create an 80% by weight coated fiber composite. The extruder barrel temperatures were set from 170° C.-200° C. and pelletized. The pellets were injection molded on a ⅝″ injection-mold into test plaque for physical property evaluation.

### Ex. 3

Glass fibers from John Mansville 10-micron diameter and 4 mm length were coated with 2.0 pph interfacial modifier. The coated fibers were then compounded on a 70 mm twin screw extruder with 16.1% by weight polypropylene homopolymer MFI 12 g-10¹ min. ASTM-1238 density 0.900 g-cm⁻³ ASTM 792 and 3.9% by weight maleic anhydride modified (MA 1.5-1.9 wt. %) polypropylene MFI 250 g-10⁻¹ min to create a coated fiber composite. The extruder barrel temperatures were set from 170° C.-200° C. and pelletized. The pellets were injection molded on a ⅝″ injection-mold into test plaque for physical property evaluation.

The claims may suitably comprise, consist of, or consist essentially of, or be substantially free or free of any of the disclosed or recited elements. The claimed technology is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

While the above specification shows an enabling disclosure of the composite technology, other embodiments may be made with the claimed materials. Accordingly, the invention is embodied solely in the claims hereinafter appended.

We claim:

1-22. (canceled)

23. A thermoplastic master batch composition comprising:
(i) at least 70 wt. % of a glass fiber, having about 0.5 to 2 wt. % of an interfacial modifier, the percentages based on the glass fiber;
(ii) about 1 to 10 wt. % of a polyolefin polymer having a 0.2 to 5 wt. % of a polar side group grafted thereto and having a melt flow index of greater than 80 g-10 min⁻¹ as measured by ASTM 638.
(iii) the balance to make 100 wt. % of a polypropylene polymer having a flex modulus of greater than 700 MPa with a melt flow index less than 80 g-10 min⁻¹ (ASTM 638);

24. The composition of claim 23 where in there is about 75-80 wt. % of a glass fiber having 1.2 to 1.6 wt. % of an interfacial modifier and a diameter of 1 to 100μ and a length of 1 to 10 mm.

25. The composition of claim 23 wherein the composition comprises 10 to 20 wt. % of the polypropylene homopolymer.

26. The composition of claim 23 where in the composition comprises about 3 to 8 wt. % of a maleic anhydride grafted olefin.

27. The composition of claim 23 wherein the glass fiber has a diameter of 1 to 20μ and a length of about 1 to 5 mm.

28. The composition of claim 23, wherein the glass fiber comprises a Type E glass fiber.

29. The composition of claim 26 wherein the grafted polyolefin polymer comprises a maleic anhydride grafted polypropylene that comprises about 0.5 to about 3 wt. % of maleic anhydride, the percentage is based on the grafted polypropylene polymer.

30. The composition of claim 23 wherein the composition has a viscosity that ranges from about 10×10³ to 5×10⁶ cP.

31. The composition of claim 23 wherein the polypropylene polymer is a polypropylene homopolymer.

32. A masterbatch pellet comprising a cylindrical object with a width about 1 to 20 mm and a length of about 1 to 50 mm comprising an increased amount of the discontinuous fiber phase such that the masterbatch pellet can be combined with a polypropylene polymer at a ratio of about 10 to 2 parts by weight of polymer per part by weight of pellet.

33. A thermoplastic masterbatch composition comprising:
(i) 76 to 80 wt. % of a glass fiber, having about 0.5 to 2 wt. % of an interfacial modifier, the percentages based on the glass fiber;
(ii) about 2 to 5 wt. % of a polyolefin polymer having a 1 to 2 wt. % of a polar side group grafted thereto and having a melt flow index of greater than 80 g-10 min⁻¹ as measured by ASTM 638.
(iii) less than 15 wt. % or the balance to make 100 wt. % of a polypropylene polymer having a flex modulus of 1000-1500 MPa with a melt flow index less than 80 g-10 min⁻¹ by (ASTM 638).

34. The composition of claim 33 where in there is about 77-79 wt. % of a glass fiber having 1.2 to 1.6 wt. % of an interfacial modifier and a diameter of 1 to 100μ and a length of 1 to 10 mm.

35. The composition of claim 33 wherein the composition comprises 10 to 20 wt. % of a polypropylene homopolymer.

36. The composition of claim 33 where in the composition comprises about 3 to 8 wt. % of a maleic anhydride grafted olefin.

37. The composition of claim 33 wherein the glass fiber has a diameter of 1 to 20μ and a length of about 1 to 5 mm.

38. The composition of claim 33, wherein the glass fiber comprises a Type E glass fiber.

39. The composition of claim 38 wherein the grafted polyolefin polymer comprises a maleic anhydride grafted polypropylene that comprises about 0.5 to about 3 wt. % of a maleic anhydride, the percentage is based on the grafted polypropylene.

40. The composition of claim 33 wherein the composition has a viscosity that ranges from about 10×10³ to 5×10⁶ cP.

41. The composition of claim 33 wherein the polypropylene polymer is a polypropylene homopolymer.
